(19) United States
(12) Patent Application Publication
(10) Pub. No.: US 2023/0006279 A1
(43) Pub. Date: Jan. 5, 2023

(54) TRACTION BATTERY

(71) Applicant: Mahle International GmbH, Stuttgart (DE)

(72) Inventors: Tihomir Angelov, Ludwigsburg (DE); Armando Coelho, Stuttgart (DE); Achim Gommel, Weil der Stadt (DE); Volker Kirschner, Muehlacker (DE); Marc Leuthold, Rudersberg (DE); Hans Christian Uibeleisen, Backnang (DE)

(21) Appl. No.: 17/839,422

(22) Filed: Jun. 13, 2022

(30) Foreign Application Priority Data
Jun. 14, 2021 (DE) 10 2021 206 050.1

(51) Int. Cl. H01M 10/6556; H01M 10/613; H01M 10/625; H01M 50/152

(52) U.S. Cl. CPC H01M 10/6556; H01M 10/613; H01M 10/625; H01M 50/152; H01M 2220/20

(57) ABSTRACT

A traction battery of a motor vehicle is disclosed. The traction battery includes a housing having a housing pot and a lid closing the housing pot. A plurality of components to be cooled are arranged in the housing. A cooling device having at least one cooling channel is arranged within the housing and connected to the components to be cooled in a heat-transferring manner. At least one insert is provided. The components to be cooled lie against the at least one insert in a heat-transferring manner.

### CROSS-REFERENCE TO RELATED APPLICATION

This application claims priority to German Application No. DE 10 2021 206 050.1 filed on Jun. 14, 2021, the contents of which are hereby incorporated by reference it its entirety.

### TECHNICAL FIELD

The invention relates to a traction battery for a motor vehicle having a housing and having multiple components to be cooled arranged in the housing.

### BACKGROUND

A traction battery usually includes multiple battery modules and a housing in which the battery modules are arranged. During the operation of the traction battery, the battery modules generate heat which is transported for example to the outside via the housing. Here, the housing is metallic in design in order to make possible a necessary high heat conduction between the battery modules and the housing. The housing is then formed from metal as a die casting. Disadvantageously, this results in a high utilisation of metal.

The object of the invention therefore is to state an improved or at least an alternative embodiment for a traction battery of the generic type with which the described disadvantages are overcome.

According to the invention, this object is solved through the subject of the independent claim(s). Advantageous embodiments are subject of the dependent claims.

### SUMMARY

A traction battery for a motor vehicle comprises a housing having a pot-shaped housing pot and a lid closing the housing pot. In addition, the traction battery comprises multiple components to be cooled arranged in the housing. The traction battery also comprises a cooling device with at least one cooling channel that can be flowed through by a cooling medium, preferentially by a cooling liquid. Here, the cooling device is arranged within the housing and connected to the respective components to be cooled in a heat-transferring manner. According to the invention, the traction battery comprises at least one plate-like insert and the cooling channel of the cooling device is delimited towards the outside by the housing pot in regions and by the insert in regions. The housing pot and the lid are formed from plastic and the at least one insert from metal. The respective components of the traction battery to be cooled lie against the insert in a heat-transferring manner.

Accordingly, only the insert, which is connected to the components to be cooled in a heat-transferring manner, is formed from metal in the traction battery according to the invention. The housing pot and the lid, which are not directly connected to the components to be cooled in a heat-transferring manner, are formed from plastic. In other words, only the regions in the traction battery according to the invention which are in direct heat-transferring contact with the components of the traction battery to be cooled are formed from metal. This results in cost, weight and material advantages.

Advantageously, the component to be cooled can be a battery module consisting of multiple battery cells stacked against one another. Advantageously, the component to be cooled can be a control board for controlling the traction battery and/or a battery module or multiple battery modules of the traction battery.

Advantageously, the insert can be formed in a deep-drawing method or in a die-casting method or in an extrusion method.

Advantageously, the insert can be plate-shaped. Advantageously, the at least one insert can be plate-shaped and have a complex shape. Advantageously, the at least one insert can have a complex shape for the space-saving arranging of the components to be cooled in the housing.

Advantageously it can be provided that the at least one insert is sealed-off towards the housing pot. Because of this, the cooling channel that can be flowed through by the cooling medium, preferentially by the cooling liquid, is also sealed-off from the components to be cooled.

In an advantageous embodiment it can be provided that at the edge and circumferentially the at least one insert is overmoulded by a plastic, preferentially by a thermoplastic. Then, the at least one insert is material bonded to the housing pot via the overmoulded plastic, preferentially welded or vibration-welded. Because of this, the cooling channel can be securely sealed-off from the components to be cooled within the housing.

In addition it can be provided that the at least one insert is connected to the lid at the edge and circumferentially in a material bonded manner via the overmoulded plastic, preferentially welded or vibration-welded. Alternatively or additionally it can be provided that the lid is connected to the housing pot at the edge and circumferentially in a material bonded manner, preferentially welded or vibration-welded. In both cases, the housing can be securely sealed-off towards the outside because of this.

In another advantageous embodiment it can be provided that the at least one insert is embedded in the housing pot under the effect of heat at the edge and circumferentially. Because of this, the cooling channel can be securely sealed-off from the components to be cooled within the housing. The lid is then connected to the housing pot at the edge and circumferentially in a material bonded manner, preferentially welded or vibration-welded. Because of this, the housing can be securely sealed-off towards the outside.

In an advantageous embodiment it can be provided that the at least one insert comprises a bonding seam facing the housing pot and is bonded to the housing pot at the edge and circumferentially via the bonding seam. Then, the bonding seam forms a seal which securely seals-off the cooling channel from the components to be cooled within the housing. Advantageously it can be provided that the at least one insert comprises a bonding seam facing the lid and is bonded to the lid via the bonding seam at the edge and circumferentially. Because of this, the housing can be securely sealed-off towards the outside.

In an advantageous embodiment it can be provided that the housing pot and the lid are joined to one another in a material bonded manner at the edge and circumferentially. Then, the at least one insert can be overmoulded with elastomer at the edge and circumferentially and because of this a sealing lip can be formed on the at least one insert. The sealing lip of the at least one insert can then be compressed between the housing pot and the lid at the edge and circumferentially. Because of this, the cooling channel can be securely sealed-off from the components to be cooled within the housing and the housing towards the outside. Advantageously, the sealing lip can comprise multiple sealing ribs. During the compression, the sealing ribs can be pressed in between the housing pot and the lid. By way of the sealing ribs, the sealing effect of the sealing lip can be additionally reinforced.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 a sectional view of a traction battery according to the invention;

FIGS. 2 to 5 sectional views of joining locations formed differently in the traction battery according to the invention.

### DETAILED DESCRIPTION

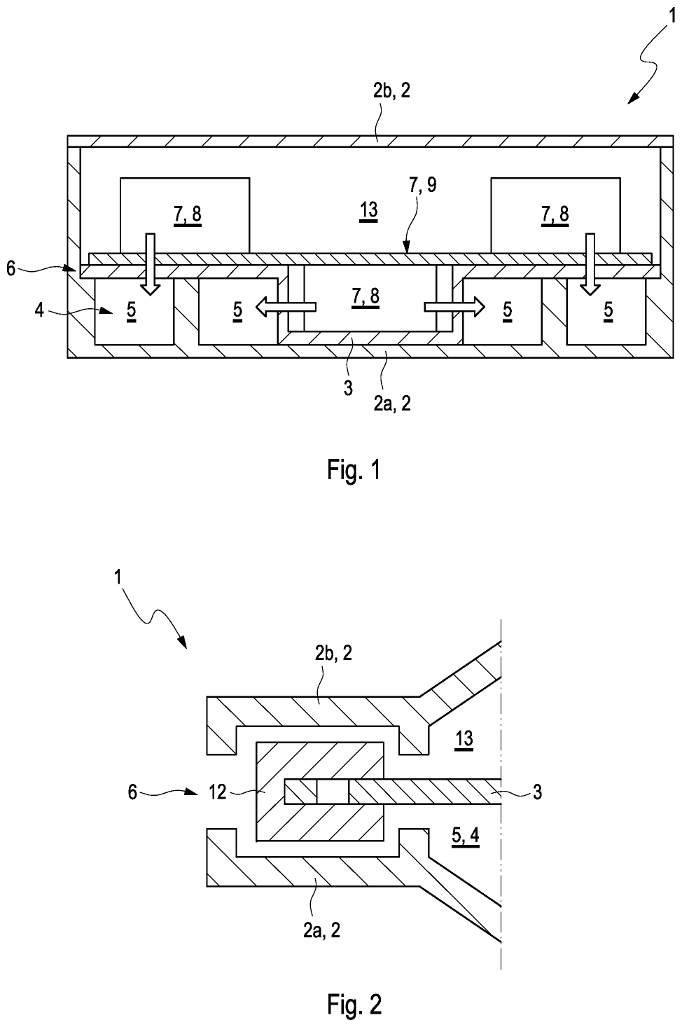

FIG. 1 shows a sectional view of a traction battery 1 according to the invention. The traction battery 1 comprises a housing 2 having a housing pot 2a and having a lid 2b and an insert 3. The insert 3 is plate-shaped and has a complex step-like shape. The housing pot 2a is pot-shaped. Here, the lid 2b is flat or plane, but can also be pot-shaped. The traction battery 1 additionally comprises a cooling device 4 with a cooling channel 5. The cooling channel 5 of the cooling device 4 is delimited towards the outside by the insert 3 and the housing pot 2a. The housing pot 2a and the lid 2b and the insert 3 are sealingly connected to one another at a joining location 6 at the edge and circumferentially.

In addition, the traction battery comprises multiple components 7 to be cooled which, here, are multiple battery modules 8 and a control board 9. The components 7 to be cooled are arranged in an interior 13 of the housing 2 which is formed within the housing 2 between the insert 3 or the housing pot 2a and the lid 2b. Here, the components 7 to be cooled are connected to the insert 3 in a heat-transferring manner so that heat—as indicated by arrows in FIG. 1—can be given off via the insert 3 to the cooling medium, preferentially the cooling liquid, in the cooling channel 5.

The housing pot 2a and the lid 2b are formed from plastic. The insert 3 is formed from metal in a deep-drawing method or in a die-casting method or in an extrusion method. Thus, exclusively the insert 3, which is in a direct heat-transferring contact with the components 7 to be cooled is formed from metal in the traction battery 1 according to the invention. By contrast, the housing 2 is completely formed from plastic. This produces cost, weight and material advantages.

FIG. 2 shows a sectional view of the traction battery 1 at the joining location 6 in a first embodiment. Here, the insert 3 is overmoulded with plastic circumferentially and at the edge, preferentially with a thermoplastic. The housing pot 2a is vibration-welded to the insert 3 with the overmoulded plastic 12. Because of this, the cooling channel 5 is securely sealed-off from the components 7 to be cooled in the housing 2 or in the interior 13 of the housing 2. The lid 2b is vibration-welded to the insert 3 with the overmoulded plastic 12. Because of this, the housing 2 is now securely sealed-off towards the outside. Thus, the housing pot 2a and the lid 2b are each connected in a material bonded manner to the insert 3 and via the insert 3 at the joining location 6.

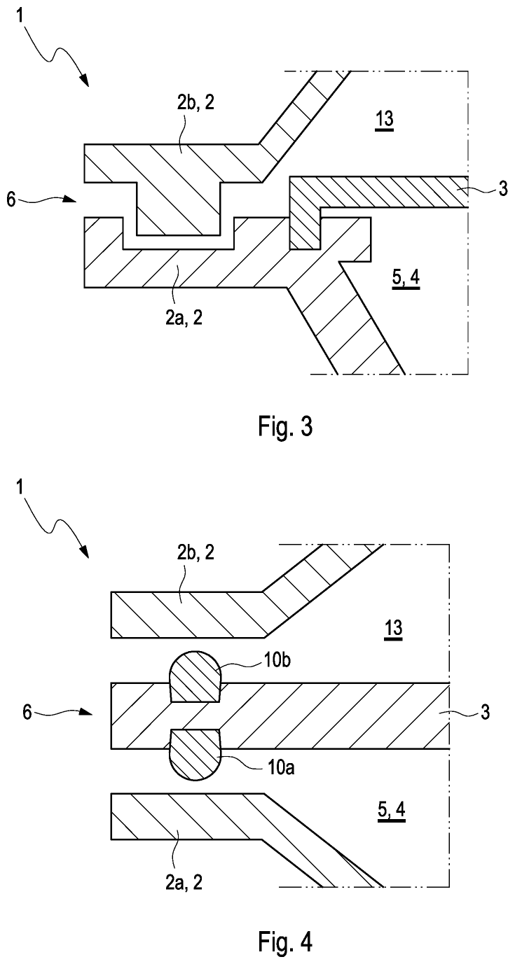

FIG. 3 shows a sectional view of the traction battery 1 at the joining location 6 in a second embodiment. Here, the insert 3 is embedded in the housing pot 2a under the effect of heat circumferentially and at the edge. Because of this, the cooling channel 5 is securely sealed-off from the components 7 to be cooled in the housing 2 or in the interior 13 of the housing 2. The housing pot 2a and the lid 2b are vibration-welded to one another at the edge and circumferentially. Because of this, the housing 2 is now securely sealed-off towards the outside. Thus, the housing pot 2a and the lid 2b are directly connected to one another in a material bonded manner at the joining location 6. Then, the insert 3 is connected to the housing pot 2a in a material bonded manner.

FIG. 4 shows a sectional view of the traction battery 1 at the joining location 6 in a third embodiment. Here, the insert 3 comprises a bonding seam 10a facing the housing pot 2a and is bonded to the housing pot 2a at the edge and circumferentially via the bonding seam 10a. Because of this, the cooling channel 5 is securely sealed-off from the components 7 to be cooled in the housing 2 or in the interior 13 of the housing 2. In addition, the insert 3 comprises a bonding seam 10b facing the lid 2b and is bonded to the lid 2b at the edge and circumferentially via the bonding seam 10b. Because of this, the housing 2 is sealed-off towards the outside. Thus, the housing pot 2a and the lid 2b are each connected at the joining location 6 to the insert 3 and via the insert 3 in a material bonded manner.

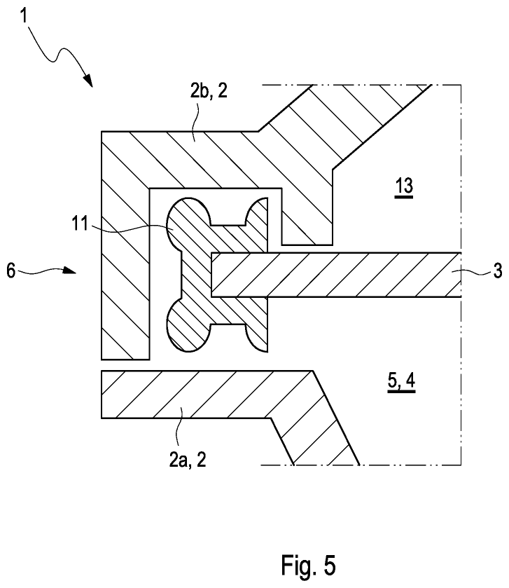

FIG. 5 shows a sectional view of the traction battery at the joining location 6 in a fourth embodiment. The insert 3 is overmoulded with elastomer at the edge and circumferentially as a result of which a sealing lip 11 is formed on the insert 3. The housing pot 2a and the lid 2b are joined to one another at the edge and circumferentially in a material bonded manner and the sealing lip 11 is compressed between the housing pot 2a and the lid 2b. Because of this, the cooling channel 5 is now securely sealed-off from the component 7 to be cooled in the housing 2 or in the interior 13 of the housing 2 and the housing 2 towards the outside.

1. A traction battery for a motor vehicle, comprising:
a housing having a pot-shaped housing pot and lid closing the housing pot,
a plurality of components to be cooled arranged in the housing,
a cooling device having at least one cooling channel that can be flowed through by a cooling medium,
wherein the cooling device is arranged within the housing and is connected to the plurality of components to be cooled in a heat-transferring manner,
at least one plate-like insert and the at least one cooling channel of the cooling device is delimited towards an outside by the housing pot in at least one region and by the at least one insert in at least one region,
the housing pot and the lid are composed of plastic and the at least one insert composed of metal, and
the plurality of components to be cooled lie against the at least one insert in a heat-transferring manner.

2. The traction battery according to claim 1, wherein the at least one insert is a deep-drawn insert, die-cast insert, or an extruded insert.

3. The traction battery according to claim 1, wherein at least one of:
at least one of the plurality of components to be cooled includes a battery module of multiple battery cells stacked against one another, and
at least one of the plurality of components to be cooled includes a control board at least one of for controlling the traction battery and of a battery module of the traction battery.

4. The traction battery according to, claim 1, wherein the at least one insert is sealed-off towards the housing pot.

5. The traction battery according to claim 1, wherein:
the at least one insert is overmoulded by a plastic at an edge and circumferentially, and
the at least one insert is connected to the housing pot via the overmoulded plastic in a material bonded manner.

6. The traction battery according to claim 5, wherein at least one of:
the at least one insert is connected to the lid via the overmoulded plastic at an edge and circumferentially in a material bonded manner, and
the lid is connected to the housing pot at an edge and circumferentially in a material bonded manner.

7. The traction battery according to claim 1, wherein:
the at least one insert is embedded in the housing pot under the effect of heat at an edge and circumferentially, and
the lid is connected to the housing pot at an edge and circumferentially in a material bonded manner.

8. The traction battery according to claim 1, wherein the at least one insert includes a bonding seam facing the housing pot and is bonded to the housing pot at an edge and circumferentially via the bonding seam.

9. The traction battery according to claim 8, wherein the at least one insert includes a further bonding seam facing the lid and is bonded to the lid via the further bonding seam at the edge and circumferentially.

10. The traction battery according to claim 1, wherein:
the housing pot and the lid are joined to one another at an edge and circumferentially in a material bonded manner,
the at least one insert is overmoulded with elastomer at an edge and circumferentially and defines a sealing lip, and
the sealing lip of the at least one insert is compressed between the housing pot and the lid at the edge and circumferentially.

11. A motor vehicle, comprising: a traction battery, the traction battery including:
a housing having a pot-shaped housing pot and a lid closing the housing pot,
a plurality of components to be cooled arranged in the housing,
a cooling device having at least one cooling channel that can be flowed through by a cooling medium,
wherein the cooling device is arranged within the housing and is connected to the plurality of components to be cooled in a heat-transferring manner,
at least one plate-like insert and the at least one cooling channel of the cooling device is delimited towards an outside by the housing pot in at least one region and by the at least one insert in at least one region,
the housing pot and the lid are composed of plastic and the at least one insert composed of metal, and
the plurality of components to be cooled lie against the at least one insert in a heat-transferring manner.

12. The motor vehicle according to claim 11, wherein the at least one insert is a deep-drawn metal insert, a die-cast metal insert, or an extruded metal insert.

13. The motor vehicle according to claim 11, wherein at least one of:
at least one of the plurality of components to be cooled includes a battery module of multiple battery cells stacked against one another; and
at least one of the plurality of components to be cooled includes a control board at least one of for controlling the traction battery and of a battery module of the traction battery.

14. The motor vehicle according to claim 11, wherein the at least one insert is sealed-off towards the housing pot.

15. The motor vehicle according to claim 11, wherein the at least one insert is overmoulded by a plastic at an edge and circumferentially, and wherein the at least one insert is connected to the housing pot via the overmoulded plastic via a welded connection or a vibration-welded connection.

16. The motor vehicle according to claim 15, wherein at least one of:
the at least one insert is connected to the lid via the overmoulded plastic at an edge and circumferentially in a materially bonded manner, and
the lid is connected to the housing pot at an edge and circumferentially in a materially bonded manner.

17. The motor vehicle according to claim 11, wherein the at least one insert is embedded in the housing pot, and wherein the lid is connected to the housing pot at an edge and circumferentially in a materially bonded manner.

18. The motor vehicle according to claim 11, wherein the at least one insert includes a bonding seam facing the housing pot and is bonded to the housing pot at an edge and circumferentially via the bonding seam.

19. The motor vehicle according to claim 11, wherein the at least one insert includes a bonding seam facing the lid and is bonded to the lid at an edge and circumferentially via the bonding seam.

20. The motor vehicle according to claim 11, wherein:
the housing pot and the lid are joined to one another at an edge and circumferentially in a materially bonded manner,
the at least one insert is overmoulded with elastomer at an edge and circumferentially such that a sealing lip is provided on the at least one insert via the overmoulded elastomer, and
the sealing lip of the at least one insert is compressed between the housing pot and the lid at the edge and circumferentially.
